(19) United States
(12) Patent Application Publication
(10) Pub. No.: US 2025/0296860 A1
(43) Pub. Date: Sep. 25, 2025

(54) ELECTROCHEMICAL FOAM FRACTIONATION AND OXIDATION TO CONCENTRATE AND MINERALIZE PERFLUOROALKYL SUBSTANCES

(71) Applicant: Evoqua Water Technologies LLC, Pittsburgh, PA (US)

(72) Inventor: Chen Yang, Lowell, MA (US)

(21) Appl. No.: 18/862,048

(22) PCT Filed: May 2, 2023
(86) PCT No.: PCT/US2023/020671

§ 371 Date: Oct. 31, 2024

Related U.S. Application Data
(60) Provisional application No. 63/337,319, filed on May 2, 2022.

(51) Int. Cl. C02F 1/465; C02F 1/28; C02F 1/42; C02F 1/461; C02F 1/467; C02F 101/36

(52) U.S. Cl. CPC C02F 1/465; C02F 1/283; C02F 1/42; C02F 1/46109; C02F 1/4672; C02F 2001/46142; C02F 2001/46147; C02F 2101/36; C02F 2209/02; C02F 2209/03; C02F 2209/40

(57) ABSTRACT

Systems and methods for treating water containing TOC and PFAS are disclosed. An electrochemical cell may be used to concentrate the PFAS via foam fractionation. The electrochemical cell may destroy TOC and some PFAS compounds. A downstream mineralization process may destroy PFAS compounds in the foam fraction.

### CROSS-REFERENCE TO RELATED APPLICATION

This application claims priority to U.S. Provisional Patent Application Ser. No. 63/337,319, filed on May 2, 2022 and titled “ELECTROCHEMICAL FOAM FRACTIONATION AND OXIDATION TO CONCENTRATE AND MINERALIZE PERFLUOROALKYL SUBSTANCES,” the entire disclosure of which is hereby incorporated herein by reference in its entirety for all purposes.

### FIELD OF TECHNOLOGY

Aspects and embodiments disclosed herein are generally related to the removal and elimination of per- and polyfluoroalkyl substances (PFAS) from water.

### BACKGROUND

There is rising concern about the presence of various contaminants in municipal wastewater, surface water, drinking water and groundwater. For example, perchlorate ions in water are of concern, as well as PFAS and PFAS precursors, along with a general concern with respect to total organic carbon (TOC).

PFAS are man-made chemicals used in numerous industries. PFAS molecules typically do not break down naturally. As a result, PFAS molecules accumulate in the environment and within the human body. PFAS molecules contaminate food products, commercial household and workplace products, municipal water, agricultural soil and irrigation water, and even drinking water. PFAS molecules have been shown to cause adverse health effects in humans and animals.

The U.S. Environmental Protection Agency (EPA) has issued a Contaminant Candidate List (CCL 5) which includes PFAS as a broad class inclusive of any PFAS that fits the revised CCL 5 structural definition of per- and polyfluoroalkyl substances (PFAS), namely chemicals that contain at least one of the following three structures:
R-(CF2)-CF(R′)R″, where both the CF2 and CF moieties are saturated carbons, and none of the R groups can be hydrogen.
R-CF2OCF2-R′, where both the CF2 moieties are saturated carbons, and none of the R groups can be hydrogen.
CF3C(CF3)RR′, where all the carbons are saturated, and none of the R groups can be hydrogen.

The EPA's Comptox Database includes a CCL 5 PFAS list of over 10,000 PFAS substances that meet the Final CCL 5 PFAS definition. The EPA has committed to being proactive as emerging PFAS contaminants or contaminant groups continue to be identified and the term PFAS as used herein is intended to be all inclusive in this regard.

### SUMMARY

In accordance with one or more aspects, a method of treating water containing total organic carbon (TOC) and per- and poly-fluoroalkyl substances (PFAS) is disclosed. The method may involve subjecting the water containing TOC and PFAS to an electrochemical foam fractionation process to produce a foam enriched in PFAS while simultaneously destroying the TOC, collecting the foam enriched in PFAS, and directing the foam enriched in PFAS to a mineralization process for destruction of the PFAS.

In some aspects, the electrochemical foam fractionation process may involve applying an electric current to electrodes of an electrochemical cell to promote water splitting. In some non-limiting aspects, the electrodes may include a titanium electrode material. The electrodes may include a surface coating or modification.

In some aspects, the method may further involve controlling the production of microbubbles and/or nanobubbles in the foam enriched in PFAS. In some non-limiting aspects, the method may further involve adjusting a temperature, pressure, flow rate and/or flow direction of the water containing TOC and PFAS in connection with the electrochemical foam fractionation process.

In some aspects, short chain PFAS compounds may be mineralized along with destruction of the TOC.

In some aspects, the method may further involve concentrating the foam enriched in PFAS upstream of the PFAS mineralization process.

In some aspects, the PFAS mineralization process may be selected from the group consisting of: incineration, chemical oxidation, electro-oxidation, plasma treatment, supercritical water oxidation, and intake to an internal combustion engine. In some non-limiting aspects, the PFAS mineralization process may involve electro-oxidation via an electrochemical cell utilizing a boron-doped diamond (BDD) electrode. In at least some embodiments, the PFAS mineralization process may involve electro-oxidation via an electrochemical cell including a Magnéli phase titanium oxide anode material.

In some aspects, the method may further comprise polishing a treated water effluent stream associated with one or both of the electrochemical foam fractionation process and the PFAS mineralization process to remove trace PFAS. Activated carbon or ion exchange media may be used to adsorb trace PFAS in some non-limiting aspects.

In some aspects, the method may further comprise supplementing the electrochemical foam fractionation process with a source of air, nitrogen or oxidizing gas, or with mechanical bubble generation.

In some aspects, the method may further comprise increasing a conductivity level of the water containing TOC and PFAS.

In accordance with one or more aspects, a system for treating water containing total organic carbon (TOC) and per- and polyfluoroalkyl substances (PFAS) is disclosed. The system may include an electrochemical cell fluidly connected to a source of the water containing TOC and PFAS, the electrochemical cell configured to create a foam enriched in PFAS while simultaneously destroying the TOC, and a PFAS mineralization unit fluidly connected downstream of the electrochemical cell and configured to receive the foam enriched in PFAS for PFAS destruction.

In some aspects, the electrochemical cell may contain electrodes including a titanium electrode material. The electrodes may include a surface coating or modification.

In some aspects, the electrochemical cell may be an open cell with electrodes positioned at the bottom of the open cell.

In some aspects, the system may further include at least one sensor in communication with the electrochemical cell.

In some aspects, the electrochemical cell may be further configured to destroy short chain PFAS compounds along with the TOC.

In some aspects, the PFAS mineralization unit may be selected from the group consisting of: an incinerator, a chemical oxidation unit, an electro-oxidation unit, a plasma unit, a supercritical water oxidation unit, and an internal combustion engine. In some non-limiting aspects, the electro-oxidation unit may include an electrochemical cell utilizing a boron-doped diamond (BDD) electrode. In some specific aspects, the electro-oxidation unit may include an electrochemical cell having a Magnéli phase titanium oxide anode material.

In some aspects, the system may further include a polishing unit configured to remove trace PFAS from a treated water effluent stream associated with one or both of the electrochemical cell and the PFAS mineralization unit to remove trace PFAS. In some non-limiting aspects, the polishing unit may include activated carbon or ion exchange media to adsorb trace PFAS.

In accordance with one or more aspects, a method of treating water containing per- and poly-fluoroalkyl substances (PFAS) is disclosed. The method may involve subjecting the water containing PFAS to an electrochemical foam fractionation process to produce a foam enriched in PFAS, collecting the foam enriched in PFAS, and directing the foam enriched in PFAS to a mineralization process for destruction of the PFAS.

In some aspects, the electrochemical foam fractionation process may involve applying an electric current to electrodes of an electrochemical cell to promote water splitting. In some non-limiting aspects, the electrodes may include a titanium electrode material. The electrodes may include a surface coating or modification.

In some aspects, the method may further involve controlling the production of microbubbles and/or nanobubbles in the foam enriched in PFAS.

In some aspects, the method may further involve concentrating the foam enriched in PFAS upstream of the PFAS mineralization process.

In some aspects, the PFAS mineralization process may be selected from the group consisting of: incineration, chemical oxidation, electro-oxidation, plasma treatment, supercritical water oxidation, and intake to an internal combustion engine. In some non-limiting aspects, the PFAS mineralization process may involve electro-oxidation via an electrochemical cell utilizing a boron-doped diamond (BDD) electrode. In at least some embodiments, the PFAS mineralization process may involve electro-oxidation via an electrochemical cell including a Magnéli phase titanium oxide anode material.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in the various figures is represented by a like numeral. For purposes of clarity, not every component may be labeled in every drawing. In the drawings:

FIG. 1 presents a process flow diagram associated with systems and methods for treating water containing total organic carbon (TOC) and per- and poly-fluoroalkyl substances (PFAS) in accordance with one or more embodiments.

### DETAILED DESCRIPTION

In accordance with one or more embodiments, water containing total organic carbon (TOC) and per- and poly-fluoroalkyl substances (PFAS) may be treated. An electrochemical cell may be used to concentrate PFAS via foam fractionation for downstream mineralization. The electrochemical cell may beneficially destroy TOC and some PFAS compounds. Various mineralization approaches may then be used to destroy PFAS in the foam. Overall, TOC and PFAS treatment may be performed in an effective and efficient manner with the possibility for a reduction in required capital equipment as described further herein.

PFAS are organic compounds consisting of fluorine, carbon and heteroatoms such as oxygen, nitrogen and sulfur. PFAS is a broad class of molecules that further includes polyfluoroalkyl substances. PFAS are carbon chain molecules having carbon-fluorine bonds. Polyfluoroalkyl substances are carbon chain molecules having carbon-fluorine bonds and also carbon-hydrogen bonds. Common PFAS molecules include perfluorooctanoic acid (PFOA), perfluorooctanesulfonic acid (PFOS), and short-chain organofluorine chemical compounds, such as the ammonium salt of hexafluoropropylene oxide dimer acid (HFPO-DA) fluoride (also known as GenX). PFAS molecules typically have a tail with a hydrophobic end and an ionized end. The hydrophobicity of fluorocarbons and extreme electronegativity of fluorine give these and similar compounds unusual properties. Initially, many of these compounds were used as gases in the fabrication of integrated circuits. The ozone destroying properties of these molecules restricted their use and resulted in methods to prevent their release into the atmosphere. But other PFAS such as fluoro-surfactants have become increasingly popular. PFAS are commonly use as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply. Further, PFAS have been utilized as key ingredients in aqueous film forming foams (AFFFs). AFFFs have been the product of choice for firefighting at military and municipal fire training sites around the world. AFFFs have also been used extensively at oil and gas refineries for both fire training and firefighting exercises. AFFFs work by blanketing spilled oil/fuel, cooling the surface, and preventing re-ignition. PFAS in AFFFs have contaminated the groundwater at many of these sites and refineries, including more than 100 U.S. Air Force sites.

Although used in relatively small amounts, these compounds are readily released into the environment where their extreme hydrophobicity as well as negligible rates of natural decomposition results in environmental persistence and bioaccumulation. It appears as if even low levels of bioaccumulation may lead to serious health consequences for contaminated animals such as human beings, the young being especially susceptible. The environmental effects of these compounds on plants and microbes are as yet largely unknown. Nevertheless, serious efforts to limit the environmental release of PFAS are now commencing.

It may be desirable to have flexibility in terms of what type of approach is used for treating water containing PFAS. For example, the source and/or constituents of the process water to be treated may be a relevant factor. The properties of PFAS compounds may vary widely. Various federal, state and/or municipal regulations may also be factors. The U.S. Environmental Protection Agency (EPA) developed revised guidelines in May 2016 of a combined lifetime exposure of 70 parts per trillion (PPT) for PFOS and PFOA. In June 2022, this EPA guidance was tightened to a recommendation of 0.004 ppt lifetime exposure for PFOA and 0.02 ppt lifetime exposure for PFOS. Federal, state, and/or private bodies may also issue relevant regulations. Market conditions may also be a controlling factor. These factors may be variable and therefore a preferred water treatment approach may change over time.

In accordance with one or more embodiments, there is provided systems and methods of treating water containing PFAS. The water may contain at least 10 ppt PFAS, for example, at least 1 ppb PFAS. For example, the waste stream may contain at least 10 ppt-1 ppb PFAS, at least 1 ppb-10 ppm PFAS, at least 1 ppb-10 ppb PFAS, at least 1 ppb-1 ppm PFAS, or at least 1 ppm-10 ppm PFAS.

In some embodiments, it may be desirable to concentrate the PFAS due its low concentration in order to facilitate treatment thereof. In accordance with one or more embodiments described herein, a process to concentrate PFAS compounds may involve directing a source of water containing a first concentration of PFAS compounds to an electrochemical cell, applying an electric current to the electrochemical cell, generating a foam as a result of applying the electric current, and collecting the foam containing a second concentration of PFAS compounds from the electrochemical cell, wherein the second concentration of PFAS compounds is greater than the first concentration of PFAS compounds. The foam containing the second concentration of PFAS compounds may then be further processed to destroy the PFAS therein.

In certain embodiments, the water to be treated may include PFAS with other organic contaminants. One issue with treating PFAS compounds in water is that the other organic contaminants compete with the various processes to remove PFAS. For example, if the level of PFAS is 80 ppb and the background total organic carbon (TOC) is 50 ppm, a conventional PFAS removal treatment, such as an activated carbon column, may exhaust very quickly. Thus, it may be important to remove TOC prior to treating for the removal of PFAS.

In some embodiments, the systems and methods disclosed herein may be used to remove background TOC prior to destroying PFAS. The methods may be useful for oxidizing target organic alkanes, alcohols, ketones, aldehydes, acids, or others in the water. In some embodiments, the water containing PFAS further may contain at least 1 ppm TOC. For example, the water containing PFAS may contain at least 1 ppm-10 ppm TOC, at least 10 ppm-50 ppm TOC, at least 50 ppm-100 ppm TOC, or at least 100 ppm-500 ppm TOC.

In accordance with one or more embodiments, the electrochemical cell used to concentrate PFAS via foam fractionation may also address target TOC as described herein. In certain non-limiting embodiments, this disclosure describes water treatment systems for removing TOC and PFAS from water and methods of treating water containing TOC and PFAS. Systems described herein may include an electrochemical cell for concentrating PFAS via foam fractionation. The electrochemical cell may produce a first treated water effluent as well as foam enriched in PFAS. The electrochemical cell may also destroy TOC and some PFAS compounds. A downstream PFAS mineralization unit may destroy PFAS in the foam enriched in PFAS and produce a second treated water effluent. One or more polishing units may address any PFAS remaining in the first and/or second treated water effluent streams. The polishing unit may be a contact reactor containing a removal material, e.g., an adsorption media. Loaded adsorption media, e.g. granular activated carbon (GAC) or ion exchange resin, may be destroyed or otherwise further processed for reuse.

In at least some embodiments, water containing TOC and PFAS for treatment may undergo a concentration process prior to a PFAS enriched stream being directed to a PFAS mineralization unit operation.

In accordance with one or more embodiments, a water treatment system may include a source of water connectable by conduit to an inlet of an upstream concentration system that can produce a treated water and a stream enriched in PFAS. This upstream separation system may thus concentrate the water to be treated with respect to its PFAS content. This separation system can be any suitable separation system that can produce a stream enriched in PFAS or other compounds. For example, the upstream separation system can be a membrane concentrator with an optional dynamic membrane, reverse osmosis (RO) system, a nanofiltration (NF) system, an ultrafiltration system (UF), or electrochemical separations methods, e.g., electrodialysis, electrodeionization, etc. In such implementations, the reject, retentate or concentrate streams from these types of separation systems will include water enriched in PFAS. For example, the concentration increase of PFAS in the water upon concentrating may be at least 20× relative to the initial concentration of PFAS before concentration, e.g., at least 20×, at least 25×, at least 30×, at least 35×, at least 40×, at least 45×, at least 50×, at least 55×, at least 60×, at least 65×, at least 70×, at least 75×, at least 80×, at least 85×, at least 90×, at least 95×, or at least 100×.

In accordance with one or more embodiments, a foam fractionation process may be used to generate a process stream enriched in PFAS. Foam fractionation may be used alone or in conjunction with one or more of the other concentration approaches discussed above. By example, a first concentration stage may concentrate PFAS by several orders of magnitude. The process stream containing PFAS may then be further concentrated, such as via foam fractionation, by several additional orders of magnitude, with PFAS concentrations increasing by example from ppt levels up to ppb or even ppm levels to enable further treatment or destruction.

In accordance with one or more embodiments, foam fractionation may be used for concentration of the source water upstream of PFAS mineralization. In foam fractionation, foam produced in water generally rises and removes hydrophobic molecules from the water. Foam fractionation has typically been utilized in aquatic settings, such as aquariums, to remove dissolved proteins from the water. During foam fractionation, gas bubbles rise through a vessel of contaminated water, forming a foam that has a large surface area air-water interface with a high electrical charge. The charged groups on PFAS molecules adsorb to the bubbles of the foam and form a surface layer enriched in PFAS that can subsequently be removed. The bubbles may be formed using any suitable gas, such as compressed air or nitrogen. In some embodiments, the bubbles are formed from an oxidizing gas, such as ozone to aid in preventing competing compounds such as metals or other organics from affecting PFAS removal, which competing compounds are likely to be in much larger concentrations than PFAS. Foam fractionation systems useful for the invention are known in the art. Multiple stages may be incorporated into a foam fractionation process. Each stage will further concentrate the PFAS compounds which also results in a smaller volume of liquid. It is possible to reduce the volume by more than 99% and increase the concentration by over 200 times using foam fractionation processes. PCT publication WO2019111238 is hereby incorporated herein by reference in its entirety for all purposes.

In accordance with one or more embodiments, an electrochemical approach to foam fractionation may be implemented. Electrochemical foam fractionation (e-FF) may be implemented to concentrate PFAS. Electrochemical foam fractionation may produce foam enriched in PFAS and a treated water effluent. The foam enriched in PFAS may then be collected and directed to a downstream unit operation for PFAS mineralization and destruction.

In accordance with one or more embodiments, an electrochemical cell may facilitate electrochemical foam fractionation. The electrochemical cell may generally include electrodes, e.g. an anode and a cathode, to which an electric current may be applied. Without wishing to be bound by any particular theory, the applied electric current may promote water splitting which may, in turn, introduce microbubbles and/or nanobubbles for foam creation with the gas liberated from electrochemical reaction being used for foam fractionation.

In accordance with one or more embodiments, nanobubbles may have a mean diameter of less than about 1 μm. In some embodiments, nanobubbles may have a mean diameter ranging from about 75 nm to about 200 nm. In at least some embodiments, a concentration of nanobubbles may be in the range of about 1×10⁶ to about 1×10⁸ nanobubbles per mL. In some specific non-limiting embodiments, nanobubbles may exhibit neutral buoyancy.

The foam may be enriched in PFAS as discussed above and may be subsequently separated and collected for downstream treatment.

In accordance with various embodiments, the efficiency of the electrochemical foam fractionation process may highly depend on the catalytical performance of the employed electrodes in terms of associated water splitting reactions. For example, platinum is known by those skilled in the relevant art to be the most active hydrogen evolution catalyst and would therefore tend to create more fine bubbles compared to other materials in terms of improving performance of foam formation.

In accordance with one or more embodiments, various electrode materials may be used. In some embodiments, a titanium based electrode material may be used. In other embodiments, a platinum based electrode material may be used. In accordance with one or more embodiments, the electrodes may include a surface coating or modification to promote gas generation. For example, the electrodes may include a platinum or an iridium oxide coating. In at least some embodiments, the electrodes may be characterized as substantially porous. The catalytic activity of different electrodes towards different water splitting reactions may be a significant design consideration. Hydrogen evolution would generally be favored in terms of facilitating foam fractionation. In some non-limiting embodiments, relevant water splitting reactions may be represented as follows:

2H₂O₍ₗ₎→4H⁺_{(g)}+4e⁻+O_{2(g)} Oxidation Reaction

4H⁺+4e⁻→2H_{2(g)} Reduction Reaction

2H₂O→2H_{2(g)}+O_{2(g)} Overall Reaction

In accordance with one or more embodiments, the electrodes may be strategically positioned within the electrochemical cell to promote foam formation and fractionation. In at least some embodiments, the electrochemical cell may be a substantially open cell with the electrodes positioned at the bottom of the cell.

In accordance with one or more embodiments, conductivity of the water to be treated may be increased to promote electrochemical foam fractionation and/or PFAS mineralization. For example, a salt solution, e.g. a sodium sulfate solution, may be added. Increased conductivity may generally be associated with decreased resistivity. In at least some embodiments, co-surfactants may be introduced.

In accordance with one or more embodiments, the production of microbubbles and/or nanobubbles in the foam enriched in PFAS may be controlled by manipulating various process parameters. A temperature, pressure, flow rate and/or flow direction of the water containing TOC and PFAS in connection with the electrochemical foam fractionation process may be adjusted. Such parameters may also be adjusted in connection with downstream PFAS mineralization. In some embodiments, the electrochemical foam fractionation process may be a batch or semi-batch process. In other embodiments, the electrochemical foam fractionation process may be a continuous or semi-continuous process. The electrochemical foam fractionation process may be supplemented with a source of air, nitrogen or oxidizing gas, or with mechanical bubble generation. Applied current, surface area and maximum current density may be design considerations in terms of manipulating hydrogen generation rates.

In accordance with one or more embodiments, TOC in the water to be treated may be destroyed by the electrochemical cell. TOC destruction may be simultaneous with the electrochemical foam fractionation process.

In accordance with one or more embodiments, select PFAS compounds, e.g. short chain PFAS compounds, may also be mineralized along with destruction of the TOC. Thus, TOC and some PFAS destruction may be performed simultaneously along with electrochemical foam fractionation to facilitate further downstream PFAS mineralization. A net capital reduction in terms of equipment may beneficially be realized as foam fractionation conventionally requires installation of multiple tanks and aeration equipment while the use of the electrochemical cell as described herein enables in situ creation of the foam fraction.

In accordance with one or more embodiments, the electrochemical foam fractionation process may be iterative or staged. Foam enriched in PFAS may be concentrated ahead of a downstream PFAS mineralization process. Foam enriched in PFAS may be returned to the electrochemical foam fractionation unit for further processing and/or subjected to other concentration approaches to achieve a desired concentration factor.

In accordance with one or more embodiments, the electrochemical foam fractionation may generally produce treated water and a foam enriched in PFAS. The foam enriched in PFAS may be collected and removed for further treatment.

In at least some aspects, the foam enriched in PFAS may contain a subset of PFAS compounds, e.g. longer chain PFAS compounds relative to any shorter chain PFAS compounds destroyed in the electrochemical foam fractionation process. The foam enriched in PFAS may represented a concentrated, high value process stream for further PFAS destruction.

In accordance with one or more embodiments, the foam enriched in PFAS may be delivered to a downstream PFAS mineralization process for further PFAS destruction. Various approaches for PFAS destruction are readily recognized by those of skill in the relevant art. In some non-limiting embodiments, the downstream PFAS mineralization process may be selected from the group consisting of: incineration, chemical oxidation, electro-oxidation, UV reduction, plasma treatment, supercritical water oxidation (SCWO), and intake to an internal combustion engine.

In accordance with one or more specific non-limiting embodiments, the PFAS mineralization process may involve advanced oxidation such as electro-oxidation via an electrochemical cell utilizing a boron-doped diamond (BDD) electrode.

In at least some non-limiting embodiments, the electrodes of the electrochemical cell may include a Magnéli phase titanium oxide (TiₙO₍₂ₙ₋₁₎) material. For example, Ti₄O₇ electrodes commercially available from Magneli Materials, Inc. may be implemented. The Magnéli phase titanium oxide material may be used for the anode along with a titanium cathode. In other embodiments, both the anode and cathode may include a Magnéli phase titanium oxide material.

Electrochemical oxidation generally involves the production of hydroxyl radicals by means of water splitting, without the need for applying any chemical additives. During the process, OH radicals are produced on a material that causes an overpotential high enough for the oxygen evolution reaction to occur when applying lower potentials. Such materials often include BDD and metal oxides materials such as titanium oxides. Metal oxide materials have become more popular because they are much cheaper. Electrochemical advanced oxidation processes may be used for PFAS degradation via indirect and direct electrooxidation. The impressive ability of BDD to defluorinate PFAS has led to its ongoing studies. Evaluation on associated current densities has suggested that degradation rates are increased when larger current densities are applied. Material properties such as BDD particle size has also been shown to influence PFAS degradation. Metal oxides such as TiO₂, and PbO₂, have also been evaluated as electrocatalytic electrode materials for PFAS degradation. Other interesting materials are Magnéli phase titanium suboxide (TSO) anodes due to their low commercial cost and high conductivity. TSO consists of a titanium oxide structure with the formula TiₙO₍₂ₙ₋₁₎, with Ti₄O₇ being the most common structure. Such materials may beneficially be useful in degrading longer chain PFAS in accordance with various embodiments disclosed herein.

In at least some non-limiting embodiments, a standard set of electrodes may be used for both the electrochemical foam fractionation and the electro-oxidation reaction.

In accordance with one or more embodiments, various effluent streams of treated water may be polished to remove any trace PFAS. For example, treated water product effluent associated with the electrochemical foam fractionation process and/or the PFAS mineralization process may be polished to remove trace PFAS. These effluent streams may have different properties. Various polishing technologies may be recognized by those skilled in the relevant art. For example, activated carbon and/or ion exchange media may be used to adsorb trace PFAS. In other embodiments, other sorbents such as, e.g., activated alumina, cyclodextrins, and/or modified silicates may be used.

Use of various adsorption media is one technique for treating water containing PFAS. The PFAS are physically captured in the pores of a porous material (i.e., physisorption) or have favorable chemical interactions with functionalities on a filtration medium (i.e., chemisorption). Activated carbon and ion exchange resin are both examples of adsorption media that may be used to capture PFAS from water to be treated. The removal material as described herein is not limited to particulate media, e.g., activated carbons, or cyclodextrins. Any suitable removal material, e.g., adsorption media, may be used to adsorb or otherwise bind with pollutants and contaminants present in the waste stream, e.g., PFAS. For example, suitable removal material may include, but are not limited to, alumina, e.g., activated alumina, aluminosilicates and their metal-coordinated forms, e.g., zeolites, silica, perlite, diatomaceous earth, surfactants, ion exchange resins, and other organic and inorganic materials capable of interacting with and subsequently removing contaminants and pollutants from the waste stream. Other adsorption media may also be implemented. Membrane processes such as nanofiltration and reverse osmosis have also been used for PFAS removal. Such techniques may be used alone or in conjunction.

In some embodiments, the dosage of adsorption media may be adjusted based on at least one quality parameter of the water to be treated. For example, the at least one quality parameter may include a target concentration of the PFAS in the treated water to be at or below a specified regulatory threshold.

Isolated trace PFAS and/or other contaminants may be destroyed on-site by any appropriate method. In other embodiments, the isolated trace PFAS or other contaminants may be removed from the site for remote destruction and/or safe storage.

In accordance with one or more embodiments, the treated water produced by the system downstream of the electrochemical cell and PFAS mineralization unit may be substantially free of the PFAS. The treated water being “substantially free” of the PFAS may have at least 90% less PFAS by volume than the waste stream. The treated water being substantially free of the PFAS may have at least 92% less, at least 95% less, at least 98% less, at least 99% less, at least 99.9% less, or at least 99.99% less PFAS by volume than the waste stream. Thus, in some embodiments, the systems and methods disclosed herein may be employed to remove at least 90% of PFAS by volume from the source of water. The systems and methods disclosed herein may remove at least 92%, at least 95%, at least 98%, at least 99%, at least 99.9%, or at least 99.99% of PFAS by volume from the source of water. In certain embodiments, the systems and methods disclosed herein are associated with a PFAS removal rate of at least about 99%, e.g., about 99%, about 99.1%, about 99.2%, about 99.3%, about 99.4%, about 99.5%, about 99.6%, about 99.7%, about 99.8%, about 99.9%, about 99.95%, or about 99.99%.

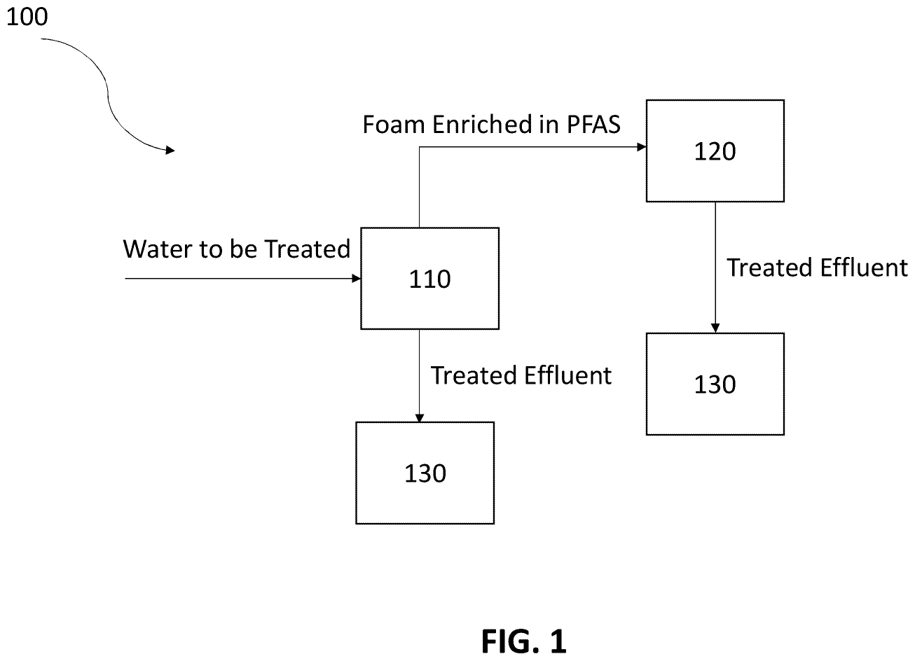

With reference to FIG. 1, a water treatment system 100 may include an electrochemical cell 110 fluidly connected to a source of water containing TOC and PFAS to be treated. The electrochemical cell 110 may produce treated water and a foam enriched in PFAS. The foam enriched in PFAS may directed to a PFAS mineralization unit 120 either directly or upon concentration thereof. Treated water effluent associated with the electrochemical cell 110 and/or the PFAS mineralization unit 120 may be further processed in one or more polishing unit operations 130 for removal of any trace PFAS as described herein. The treated water effluent streams may be different in terms material properties.

In some embodiments, systems and methods disclosed herein can be designed for centralized applications, onsite application, or mobile applications via transportation to a site. The centralized configuration can be employed at a permanent processing plant such as in a permanently installed water treatment facility such as a municipal water treatment system. The onsite and mobile systems can be used in areas of low loading requirement where temporary structures are adequate. A mobile unit may be sized to be transported by a semi-truck to a desired location or confined within a smaller enclosed space such as a trailer, e.g., a standard 53′ trailer, or a shipping container, e.g., a standard 20′ or 40′ intermodal container. Beneficially, material containing PFAS need not be transported across a relatively far distance in accordance with various embodiments. Localized removal and destruction is enabled herein.

The function and advantages of these and other embodiments can be better understood from the following example. This example is intended to be illustrative in nature and is not considered to be in any way limiting the scope of the invention.

### Example

80 ml PFAS contaminated synthetic water was freshly prepared from deionized water for demonstration of treatment. The process contains one water splitting cell to introduce bubbles in the polluted water for foam creation which is then subsequently removed by a liquid transfer pipettor. The enriched PFAS can be then treated in a boron-doped diamond (BDD) cell for mineralization. To increase conductivity of the synthetic solution, 5 mM Na₂SO₄ was added.

Case 1: Treatment of 80 ml 1 ppm PFOS Solution, e-FF by Platinum Coated Titanium Electrodes

The e-FF was conducted in a 100 ml beaker where 2 pieces of platinum coated titanium were employed as the cathode and the anode. The activated area for both electrodes is 6 cm2. During the fractionation process, current was kept at 0.5 A in the cell. A 20-200 μl Eppendorf pipette was used for foam collection and transfer. The process was stopped when visually no foam was formed. Measurement of PFOS is achieved by a Shimazu TOC-L coupled with a platinum catalyzed combustion tube. The detection limit (DL) is about 0.1 ppm TOC.

The results shown in Table 1 illustrate that majority of PFOS has been enriched and separated from the source water. The enriched PFAS can be then sent to an electrochemical oxidation cell by employing BDD as the anode for destruction and mineralization. The effectiveness of a BDD cell for PFAS has well been demonstrated in PCT application PCT/US2020/12648 that more than 99% mineralization ratio can be expected. The ratio depends on the applied current on the BDD anode and duration of treatment.

TABLE 1
e-FF to treat 80 ml 1 ppm PFOS

| | Sample volume | PFAS in TOC | Total PFAS in TOC |
|---|---|---|---|
| Samples ID | (ml) | (ppm) | (×10⁻⁶ g) |
| Before e-FF | 80 | 0.19 | 15.2 |
| After e-FF | 73.2 | Blow DL (<0.1) | N.A. |
| Enriched PFAS | 6.8 | 2.12 | 14.4 |

Case 2: Treatment of 80 ml 100 Ppb PFOA Solution, e-FF by Platinum Coated Titanium Electrodes

The e-FF is conducted in a situation similar to case 1. However, the measurement of PFOA is achieved by ion chromatography coupled with a PROTOSIL HPLC column where a solution of 10 mM boric acid and 10% acetonitrile (adjusted to pH 8) was employed as the mobile phase. The detection limit of PFOA by this method is below 20 ppb. The result is shown in table 2. After e-FF, no PFOA was detected.

TABLE 2
e-FF to treat 80 ml 100 ppb PFOA

| | | PFOA | Total PFAS |
|---|---|---|---|
| Samples ID | Sample volume | (ppb) | (×10⁻⁹ g) |
| Before e-FF | 80 | 100 | 8000 |
| After e-FF | 60 | Below DL (<20) | N.A. |
| Enriched PFAS | 20 | 365 | 7300 |

Case 3: Treatment of 80 ml 1 ppm PFOA Solution, e-FF by Comparing Pt and IrO2 Coated Titanium Electrodes

To compare the influence of different electrodes on the performance of e-FF, a pair of platinum coated titanium electrodes and a pair of IrO2 coated titanium electrodes are employed for e-FF separately. The process is similar to that has been described in case 2 and measurement is achieved by ion chromatography. The logical reason behind this is because of the catalytic activity of different materials towards different water splitting reactions. Platinum, as the most active hydrogen evolution catalyst, would tend to create more fine bubbles compared to other materials that may improve performance of foam formation. A typical result is shown in table 3, PFOA removal by e-FF via. platinum tends to be more efficient compared to via. IrO2 (0.138 ppm residual compared to 0.5 ppm) as expected since platinum should create more fine hydrogen bubbles compared to others, but more fractionated volume was also found.

TABLE 3
e-FF to treat 80 ml 1 ppm PFOA, compare
performance of Pt and IrO₂

| | | Sample | PFOA | Total PFAS |
|---|---|---|---|---|
| Electrodes | Samples ID | volume | (ppm) | (×10⁻⁶ g) |
| Pt—Pt | Before e-FF | 80 | 1 | 80 |
| | After e-FF | 60 | 0.138 | 8.28 |
| | Enriched PFAS | 20 | 3.36 | 67.2 |
| IrO₂—IrO₂ | Before e-FF | 80 | 1 | 80 |
| | After e-FF | 72 | 0.5 | 36 |
| | Enriched PFAS | 8 | 4.97 | 39.76 |

The results of these experiments show that it is possible to use an electrochemical process to generate bubbles for a foam fractionation process and that the foam fractionation process will concentrate PFAS compounds.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

1. A method of treating water containing total organic carbon (TOC) and per- and polyfluoroalkyl substances (PFAS), comprising:
subjecting the water containing TOC and PFAS to an electrochemical foam fractionation process to produce a foam enriched in PFAS while simultaneously destroying the TOC;
collecting the foam enriched in PFAS; and
directing the foam enriched in PFAS to a mineralization process for destruction of the PFAS.

2. The method of claim 1, wherein the electrochemical foam fractionation process involves applying an electric current to electrodes of an electrochemical cell to promote water splitting, the electrodes including a titanium electrode material.

3. The method of claim 2, wherein the electrodes include a surface coating or modification.

4. The method of claim 1, further comprising controlling the production of microbubbles and/or nanobubbles in the foam enriched in PFAS.

5. The method of claim 1, further comprising adjusting a temperature, pressure, flow rate and/or flow direction of the water containing TOC and PFAS in connection with the electrochemical foam fractionation process.

6. The method of claim 1, wherein short chain PFAS compounds are mineralized along with destruction of the TOC.

7. The method of claim 1, further comprising concentrating the foam enriched in PFAS upstream of the PFAS mineralization process.

8. The method of claim 1, wherein the PFAS mineralization process is selected from the group consisting of: incineration, chemical oxidation, electro-oxidation, plasma treatment, supercritical water oxidation, and intake to an internal combustion engine.

9. The method of claim 8, wherein the PFAS mineralization process involves electro-oxidation via an electrochemical cell utilizing a boron-doped diamond (BDD) electrode.

10. The method of claim 8, wherein the PFAS mineralization process involves electro-oxidation via an electrochemical cell including a Magnéli phase titanium oxide anode material.

11. The method of claim 1, further comprising polishing a treated water effluent stream associated with one or both of the electrochemical foam fractionation process and the PFAS mineralization process to remove trace PFAS.

12. The method of claim 11, wherein activated carbon or ion exchange media is used to adsorb trace PFAS.

13. The method of claim 1, further comprising supplementing the electrochemical foam fractionation process with a source of air, nitrogen or oxidizing gas, or with mechanical bubble generation.

14. The method of claim 1, further comprising increasing a conductivity level of the water containing TOC and PFAS.

15. A system for treating water containing total organic carbon (TOC) and per- and polyfluoroalkyl substances (PFAS), comprising:
an electrochemical cell fluidly connected to a source of the water containing TOC and PFAS, the electrochemical cell configured to create a foam enriched in PFAS while simultaneously destroying the TOC; and
a PFAS mineralization unit fluidly connected downstream of the electrochemical cell and configured to receive the foam enriched in PFAS for PFAS destruction.

16. The system of claim 15, wherein the electrochemical cell contains electrodes including a titanium electrode material.

17. The system of claim 16, wherein the electrodes include a surface coating or modification.

18. The system of claim 15, wherein the electrochemical cell is an open cell with electrodes positioned at the bottom of the open cell.

19. The system of claim 15, further comprising at least one sensor in communication with the electrochemical cell.

20. The system of claim 15, wherein the electrochemical cell is further configured to destroy short chain PFAS compounds along with the TOC.

21.-33. (canceled)
